(19) United States
(12) Patent Application Publication
(10) Pub. No.: US 2014/0184139 A1
(43) Pub. Date: Jul. 3, 2014

(54) CLIP-TYPE MOBILE POWER SUPPLY

(71) Applicant: Meichan Wen, ShenZhen (CN)

(72) Inventor: Meichan Wen, ShenZhen (CN)

(21) Appl. No.: 13/886,251

(22) Filed: May 2, 2013

(30) Foreign Application Priority Data
Jan. 3, 2013 (CN) 201330000086.4

(51) Int. Cl. H02J 7/00

(52) U.S. Cl. CPC H02J 7/0042
USPC 320/103

(57) ABSTRACT

This invention is a Clip-type mobile power supply. The mobile power supply and a protective sleeve is connected through a sliding buckle to form an organic whole. Mobile terminal is connected to the power supply through connectors pins. Data on the mobile terminal can also interface with external devices through external interface pins. The mobile power supply can be easily separated from the protective sleeve when it is not in use.

### CROSS-REFERENCES TO RELATED APPLICATIONS

The present application claims priority through Paris Convention to a Chinese Patent Application No. 201330000086.4 filed on Jan. 3, 2013.

### TECHNICAL FIELD

The invention relates to power supply technology, more specifically it is intended as a type of mobile power supply for smart phones with back clip.

### BACKGROUND OF THE INVENTION

With the development of technology, personal consumer electronics function also more and more powerful, such as smart mobile phone, although it is possible to provide people with more entertainment or office select, but the power consumption of mobile phone, the size is limited, the limited battery capacity, built-in battery can not provide longer life time, therefore need backup power extended to the mobile terminal battery life or to provide electrical energy in an emergency.

Existing backup power through the cable connected to the mobile phone, usually with mobile phone when using a state is in a state of separation, the inconvenience to users carry and use. In order to prevent scratch the phone's shell and reduce the influence of external shocks on mobile phones, usually in the mobile phone shell is equipped with protective sleeve. Current cases didn't have the function of the standby power, how to backup power with protective sleeve, when using standby power can and cases to form an organic whole and provide power for mobile phone, when not in use and can separate the protective sleeve and the standby power, is engineering staff need to address an important subject.

### BRIEF SUMMARY OF EMBODIMENTS OF THE INVENTION

Technical problems solved by this invention is to provide a clip-type mobile power supply, the clip-type mobile power can easily cooperate with mobile terminal protection shell, make mobile power and mobile terminals form a whole, extend the battery life of mobile terminal, when not in use and convenient to separate mobile power supply and protection shell, easy to carry and use.

In order to solve the above problem, the present invention provides a kind of Clip-type mobile power supply, comprising protective sleeve and main body, the protective sleeve is matched with the mobile terminal, the main body is matched with the protective sleeve, the main body comprising upper cover and lower cover, battery and circuit board is located between the upper and lower covers, the circuit board has a charging and discharging circuit, the connector and the external interface, the upper cover of the surface has a sliding buckle and the end of upper cover has a gap, lower cover of the end has a gap, Lower cover of the tail has a terminal cover, The connector is located in the terminal cover at one end and the other end is located outside of the terminal cover; Protective sleeve on a fixed hole, the fixed hole and the Sliding buckle to cooperate.

Preferably, the connector a comprises data pin and the charging pin; the external interface comprises a data pin and the charging pin, wherein the two data pin connected to each other, the two charging pin through the charging and discharging circuit connected to each other.

Preferably, the terminal cover was enclosed structure.

Preferably, Fixed hole shape for 8 word.

Preferably, the inside of the lower cover has a slot, the slot with the upper cover of card buckle engagement fixed.

Preferably, the sliding buckle cylindrical, T-shaped or inverted L-shaped sectional view along an axial centerline of the Movement.

Preferably, the slide buckle number stated is three, slide buckle is triangular distribution; When the slide buckle number stated is four, slide buckle is arranged in array.

Preferably, the terminal cover on the surface with the extending portion, cavity formed between the extension and the upper cover.

Preferably, The fixed hole comprising the fixed portion and the mating portion of the stepped structure, relative to the fixed portion 112 is provided with two stopper portion.

The clip-type mobile power supply, comprising protective sleeve and main body, the protective sleeve is matched with the mobile terminal, the main body is matched with the protective sleeve, the main body comprising upper cover and lower cover, battery and circuit board is located between the upper and lower covers, the circuit board has a charging and discharging circuit, the connector and the external interface, the upper cover of the surface has a sliding buckle and the end of upper cover has a gap, lower cover of the end has a gap, Lower cover of the tail has a terminal cover, The connector is located in the terminal cover at one end and the other end is located outside of the terminal cover; Protective sleeve on a fixed hole, the fixed hole and the Sliding buckle to cooperate.

When using, Mobile power supply through the sliding buckle with protective sleeve to form an organic whole, Connectors connected to the mobile terminal interface, And charging power supply pins by Connectors for mobile power supply, Extend the battery life of mobile terminals. Meanwhile, The data on the mobile terminal can pass the connector pin and the data on the external interface pins for communications with external devices, Does not affect normal use mobile terminals. When not to use mobile power supply, through the gap can easily separate the mobile power supply and protective sleeve.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 embodiment of the present invention clip-type mobile power supply breakdown structure diagram.

FIG. 2A Is part of the structure A in FIG. 1 is an enlarged schematic view.

FIG. 2B Is part of the structure B in FIG. 1 is an enlarged schematic view

FIG. 3 is Sliding buckle the direction of the C-C structure schematic cross sectional view.

FIG. 4 is another Sliding buckle the direction of the C-C structure schematic cross sectional view.

FIG. 5 is the direction of the D-D structure schematic cross sectional view.

FIG. 6 is a protective sleeve and the back clip mobile power supply after the structure schematic drawing.

FIG. 7 is the protective sleeve and the back clip mobile power supply after the separation of structure diagram.

FIG. 8 is a fixed hole structure is an enlarged schematic view.

FIG. 9 is a front fixed hole schematic structural view.

FIG. 10 is a schematic structural diagram slider in conjunction with the fixing hole.

FIG. 11 is a clip-type mobile power supply with a mobile terminal protective cover with.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

FIG. 1 Clip-type mobile power supply, comprising protective sleeve 1 and main body, the protective sleeve 1 is matched with the mobile terminal A, the main body is matched with the protective sleeve 1, the main body comprising upper cover 3 and lower cover 5, battery 4 and circuit board 6 is located between the upper and lower covers, the circuit board 6 has a charging and discharging circuit, the connector 7 and the external interface 61, the upper cover 3 of the surface has a sliding buckle 31 and the end of upper cover 3 has a gap 32, lower cover 5 of the end has a gap 52, Lower cover 5 of the tail has a terminal cover 2, The connector 7 is located in the terminal cover 2 at one end and the other end is located outside of the terminal cover 2; Protective sleeve 1 on a fixed hole 11, the fixed hole 11 and the Sliding buckle 31 to cooperate.

Specifically, the upper cover 3 and the lower cover 5 is fitted; the upper cover 3 and the lower cover 5 between have the battery 4 and the circuit board 6. End portion of the lower cover 5 there is another gap 52, the tail of the upper cover 5 has the terminal cover 2.

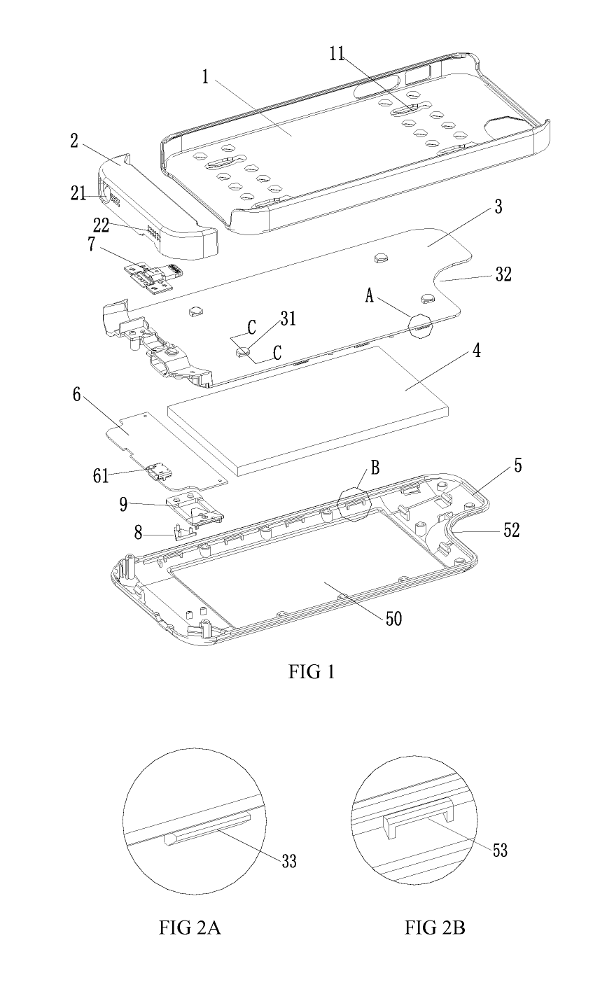

FIG. 2A and FIG. 2B, The surface of the upper cover 3 has sliding buckle 31, the end portion of the upper cover 3 has a gap 32, wherein the gap 52 and gap 32 the same location.

The inside of the lower cover 5 has a slot 53, the slot with the upper cover of card buckle engagement fixed. the upper cover 3 and the lower cover 5 is fixed, no additional parts fixed facilitate assembly.

Accommodated battery 4 cavity 50 between the the upper cover 3 and the lower cover 5. The sliding buckle cylindrical, T-shaped or inverted L-shaped sectional view along an axial centerline of the Movement.

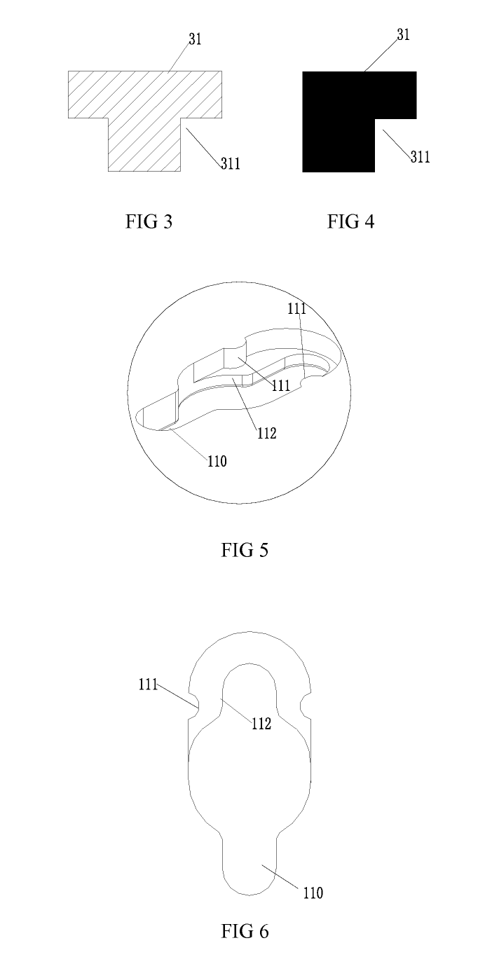

FIG. 3 and FIG. 4, the sliding buckle 31 cylindrical, T-shaped or inverted L-shaped sectional view along an axial centerline of the movement. That the sliding buckle 31 and the upper cover 3 has one or two fixing grooves 311.

The sliding buckle 31 may be fixed to the structure of the fixed hole 11. The sliding buckle 31 may be two, three or four, when the slide buckle number stated is three, slide buckle is triangular distribution; When the slide buckle number stated is four, the sliding buckle is arranged in array.

The Connector 7 comprises data interface and a charging interface. External interface 61 includes data pin and charging pin. Two data pin connected to each other, Two charging pin and charge-discharge circuit is connected. The Connector 7 can match the mobile terminal for charging. Simultaneously Connector 7 can communicate data pin and an external interface 61 and an external device.

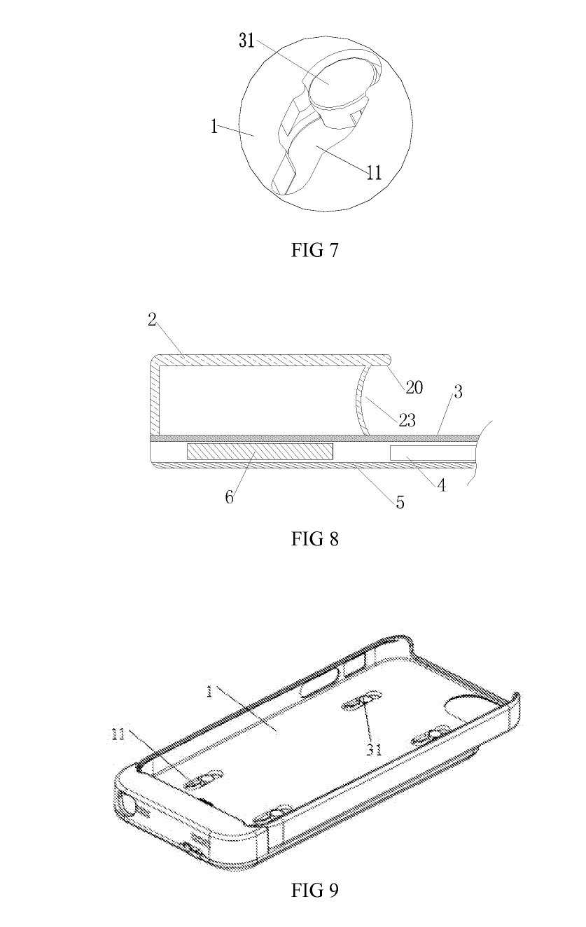

FIG. 5, FIG. 6 and FIG. 7, The fixing hole 11 comprises a stepped structure of the fixed portion 112 and the mating portion 110. Relative to each other in the fixed portion 112 has two stopper portion 111. The sliding buckle 31 is cylindrical, T-shaped or inverted L-shaped sectional view along an axial centerline.

The external interface 61 is a MICRO USB terminals other mobile power supply for charging, and communication through the external interface 61 and the mobile terminal and the external device may also be used.

When charging the battery 4, charging pin of external interface 61 with charging and discharging circuit and battery 4 is an electrical path. Can also pass by the charging pin of the external interface 61 and charging pin of the connector 7 to the mobile terminal for charging, Charging pin of external interface 61 an electrical path formed with charge-discharge circuit and the mobile terminal.

When clip-type mobile power supply through an external interface 61 connected to the charger, mobile power charge to the mobile terminal (such iPhone mobile; When iPhone mobile is fully charged, automatically switches charge clip-type mobile power supply.

Charge on iPhone, you long press charge button a certain period of time, such as 2S can stop charging on iPhone, and automatically switch to the mobile power supply charging. Release charge button, and then long press charge button a certain period of time, such as release charge 2S recoverable IPHONE, charging key press time can be set by way software. When mobile power supply automatically turns off when iPhone is fully charged or no load.

When powered by clip-type mobile power supply mobile terminals, the battery 4 energy by charging and discharging charging power supply circuit and Connector 7 on the charging pin of on mobile terminal; At the same time mobile terminal may the through the data pin of connector 7 and the data pin of external interface 61 with an external device for communication.

Use the mobile power supply through the sliding buckle 31 and protective sleeve 1 with integrally formed, the connector 7 complex interface with the mobile terminal, and the mobile terminal power supply connector on the charging pin, extending the battery life mobile terminal.

The same time the mobile terminal through data pin of the connector 7 and an data pin of the external interface 61 for communication with an external device, does not affect the normal use of mobile terminal. the mobile power supply when not in use, the upper cover 3 and the lower cover 5 gap can easily separation the mobile power supply and protective sleeve 1.

FIG. 8 the terminal cover 2 is enclosed structure. When the clip-type mobile power supply with protective sleeve fit, the mobile terminal end portion accommodated in the accommodation cavity, The end portion of the mobile terminal is the terminal cover 2 coated, The accommodation cavity allows clip-type mobile power supply mobile terminals and protective sleeve fit more closely. The side of terminal cover 2 with easy sound through the through-hole 22 and the headphone hole 21.

FIG. 8 the terminal cover 2 on the surface with the extending portion 20, cavity formed between, the extending portion 20 and the upper cover, The accommodating cavity 23 for accommodating end portion of the mobile terminal and end portion of protective sleeve, the extending portion 20, More closely with mobile power supply with protective sleeve, Shown in FIG. 9.

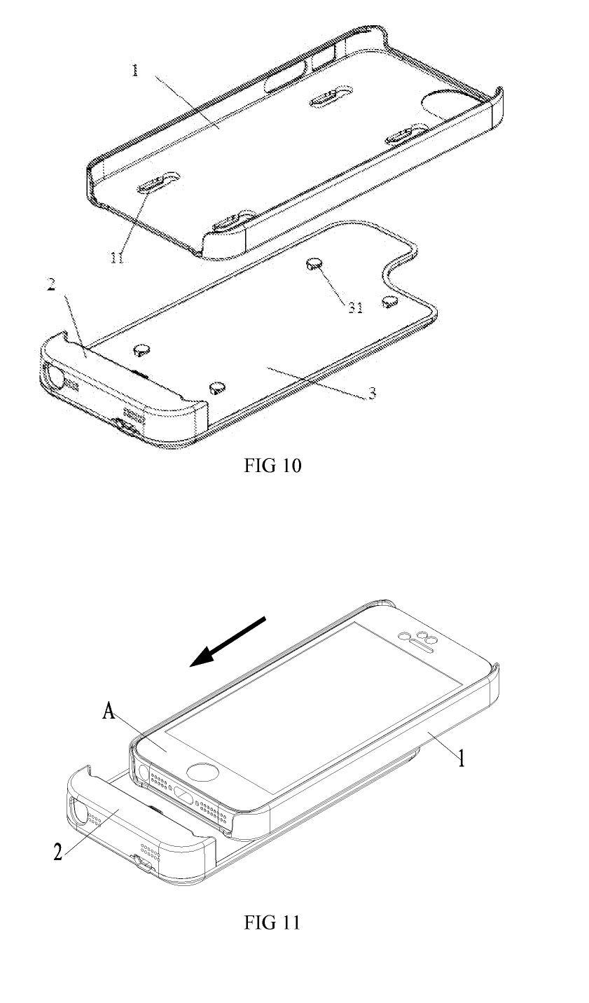

FIG. 10 the structure of state when the clip-type mobile power supply separated from the protective sleeve.

FIG. 11 the mobile power supply with state of the mobile terminal.

Needed on the circuit board 6 with electronic switch and light, Lower cover 5 on the button 8, the button 8 corresponding electronic switch position. The corresponding to position of a light pipe 9, when light can be light, through the light pipe 9 leads, user-friendly.

While certain exemplary embodiments have been described and shown in the accompanying drawings it is to be understood that such embodiments are merely illustrative of and not restrictive on the broad invention, and that this invention not be limited to the specific constructions and arrangements shown and described, since various other modifications may occur to those ordinarily skilled in the art.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. Clip-type mobile power supply, comprising protective sleeve and main body, the protective sleeve is matched with a mobile terminal, the main body is matched with the protective sleeve, the main body comprising upper cover and lower cover, battery and circuit board is located between the upper and lower covers, wherein:
the circuit board has a charging and a discharging circuit, a connector and an external interface, the upper cover of the surface has a sliding buckle and the end of upper cover has a gap, lower cover of the end has a gap, Lower cover of the tail has a terminal cover, The connector is located in the terminal cover at one end and the other end is located outside of the terminal cover; Protective sleeve on a fixed hole, the fixed hole and the sliding buckle to cooperate.

2. The Clip-type mobile power supply according to claim 1 wherein the connector a comprises data pin and the charging pin; the external interface comprises a data pin and the charging pin, wherein the two data pin connected to each other, the two charging pin through the charging and discharging circuit connected to each other.

3. The Clip-type mobile power supply according to claim 1 wherein the terminal cover is enclosed structure.

4. The Clip-type mobile power supply according to claim 1 wherein Fixed hole shape for 8 word.

5. The Clip-type mobile power supply according to claim 1 wherein the inside of the lower cover has a slot, the slot with the upper cover of card buckle engagement fixed.

6. The Clip-type mobile power supply according to claim 1 wherein the sliding buckle cylindrical, T-shaped or inverted L-shaped sectional view along an axial centerline of the Movement.

7. The Clip-type mobile power supply according to claim 1 wherein when the slide buckle number stated is three, slide buckle is triangular distribution; When the slide buckle number stated is four, slide buckle is arranged in array.

8. The Clip-type mobile power supply according to claim 1 wherein the terminal cover on the surface with the extending portion cavity formed between, the extending portion 20 and the upper cover.

9. The Clip-type mobile power supply according to claim 1 wherein The fixed hole comprising the fixed portion and the mating portion of the stepped structure, relative to the fixed portion 112 is provided with two stopper portion.
